(19) United States
(12) Patent Application Publication
(10) Pub. No.: US 2014/0337730 A1
(43) Pub. Date: Nov. 13, 2014

(54) USER INTERFACE FOR PRESENTING CONTEXTUAL INFORMATION

(71) Applicant: Google Inc., Mountain View, CA (US)

(72) Inventors: Virgil King, Arlington, MA (US); Robert Francis Keohane, Hopkinton, MA (US); Marco Paglia, San Francisco, CA (US)

(73) Assignee: Google Inc., Mountain View, CA (US)

(21) Appl. No.: 14/132,291

(22) Filed: Dec. 18, 2013

Related U.S. Application Data
(60) Provisional application No. 61/822,066, filed on May 10, 2013.

(51) Int. Cl. G06F 3/0484

(52) U.S. Cl. CPC G06F 3/0484
USPC 715/716; 715/781

(57) ABSTRACT

Context information associated with a selected portion of a media item is presented to a user via a user client. The user client receives a selection of a portion of the media item being presented to the user by the user client. The user client determines context information based on the selected portion of the media item, and generates a context presentation card using the determined context information. The user client presents a partial portion of the context presentation card containing a subset of the context information to the user.

### CROSS-REFERENCE TO RELATED APPLICATION

This application claims the priority of U.S. Provisional Patent Application No. 61/822,066, filed May 10, 2013, which is incorporated herein by reference.

### BACKGROUND

1. Field of Disclosure

This disclosure relates to the field of media presentation generally, and specifically to presenting context information for a media item.

2. Description of the Related Art

Many users utilize their digital devices to consume media content. For example it is common for users to read media content such as novels, news articles, short stories, etc., and/or view video content via their digital device. On occasion, a user may wish to retrieve information associated with a particular portion of the media content (e.g., a user may want to look up the definition of an unfamiliar word). However, many digital devices (e.g., mobile phone, tablet, etc.) used to present media content have limited display space. The lack of display space often results in the retrieved information being presented to the user in an obtrusive manner that can be detrimental to the user's media consumption experience. For example, a digital device may replace the page displaying the media content with a page directed solely to retrieved information, thus interrupting the user's consumption experience.

### SUMMARY

The above and other needs are met by a computer-implemented method, a non-transitory computer-readable storage medium storing executable code, and a system for presenting context information to a user of a user client.

One embodiment of the computer-implemented method for presenting context information to a user of a user client, comprises receiving a selection of a portion of a media item being presented to the user by the user client. Context information may be determined based on the selected portion of the media item, some other signals (e.g., user demographics, user location, user history, user preferences, etc.) or some combination thereof, and a context presentation card is generated using the determined context information. The partial portion of the context presentation card is presented containing a subset of the context information to the user.

One embodiment of a non-transitory computer-readable storage medium storing executable computer program instructions for presenting context information to a user of a user client, comprises receiving a selection of a portion of a media item being presented to the user by the user client. Context information is determined based on the selected portion of the media item, and a context presentation card is generated using the determined context information. The partial portion of the context presentation card is presented containing a subset of the context information to the user.

One embodiment of a system for presenting context information to a user of a user client, comprises a processor configured to execute modules, and a memory storing the modules. The modules include a context selection module configured to receive a selection of a portion of a media item being presented to the user by the user client. The modules also include a context identification module configured to determine context information based on the selected portion of the media item, and a card generation module configured to generate a context presentation card using the determined context information. The modules also include a user interface module configured to present a partial portion of the context presentation card containing a subset of the context information to the user.

### BRIEF DESCRIPTION OF DRAWINGS

FIG. 1 is a high-level block diagram illustrating an embodiment of an environment for presenting context information associated with a portion of a media item.

FIG. 2 is a high-level block diagram illustrating an example computer for implementing the entities shown in FIG. 1.

FIG. 3 is a high-level block diagram illustrating a detailed view of an information presentation module within a user client according to one embodiment.

FIG. 4A illustrates an example of a user interface displayed by a user client showing a context presentation card in a peeking state according to an embodiment.

FIG. 4B illustrates an example of a user interface displayed by a user client showing a context presentation card in a minimized state according to an embodiment.

FIG. 4C illustrates an example of a user interface displayed by a user client showing a context presentation card in a maximized state according to an embodiment.

FIG. 4D illustrates an example of a user interface displayed by a user client showing multiple context presentation cards in a maximized state according to an embodiment

FIG. 5 illustrates an example of a user interface displayed by a user client showing multiple context presentation cards of differing context according to an embodiment.

FIG. 6 is a flowchart illustrating a process of presenting context information to a user according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

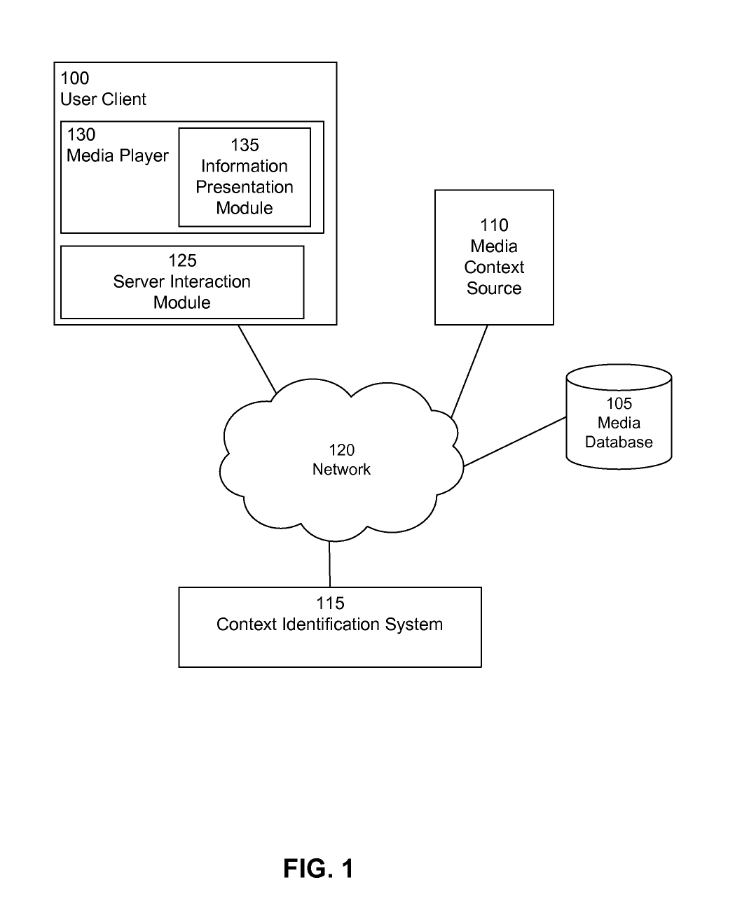

FIG. 1 is a high-level block diagram illustrating an embodiment of an environment for presenting context information associated with a portion of a media item. The environment includes a user client 100 connected by a network 120 to a media database 105, a media context source 110, and context identification system 115. Here only one user client 100, media database 105, media context source 110, and context identification system 115 are illustrated but there may be multiple instances of each of these entities. For example, there may be thousands or millions of user clients 100 in communication with multiple context identification systems 115, media databases 105, and media context sources 110.

The network 120 provides a communication infrastructure between the user client 100, the media database 105, the media context source 110, and the context identification source 115. The network 120 is typically the Internet, but may be any network, including but not limited to a Local Area Network (LAN), a Metropolitan Area Network (MAN), a Wide Area Network (WAN), a mobile wired or wireless network, a private network, or a virtual private network.

The media database 105 comprises computer servers that host media items associated with content that are made available to the user clients 100, the media context source 110, the context identification system 115, or some combination thereof. A media item is content that has been formatted for presentation to a user in a specific manner. For example, a media item may be an e-book, a video file, and image, an audio file, or content in some other format. The media database 105 may directly provide media items to the user client 100 via the network 120, or the media database 105 may provide media items to the context identification system 115, and the media items may be made available to the user client 100 from the context identification system 115.

The media context source 110 comprises one or more computer servers that store context information for portions of media items. The media context source 110 may be, for example, a website or data archive that provides lookup services (e.g., dictionary, thesaurus, and encyclopedia services). Additionally, in some embodiments, the media context source 110 may be a search engine. The media context source 110 stores and provides context information to the context identification system 115, the user client 100, or both.

Context information is information that in some way describes and/or is associated with a portion of a media item. Context information may include definition information, image information, geographic information, one or more links to locations where the context information resides or may be determined, or some combination thereof. Definition information defines a word or grouping of words, for example, definition information may define words in an e-book. Definition information may include variations of a word or phrase, declination of the word or phrase, pronunciation of the word or phrase, and snippets showing examples of usage. Geographic information describes a geographic location that is associated with the selected portion of the media item. Geographic information may include a map, location coordinates, etc. For example, if the selected portion of the media item is the word “London,” the geographic information may include a map of the city of London. Image information includes one or more images and/or videos that are associated with the selected portion of the media item. For example, if the selected portion of the media item is the word “London,” the image information may include one or more pictures and/or videos of the city of London.

The context identification system 115 identifies context information in media items. The context identification system 115 can identify context information using a context database. A context database includes context information and/or links to locations of context information that are mapped to selected portions of a plurality of media items using media identifiers and location identifiers. A context database includes, for example, a look up table, a knowledge graph, or some other data structure. Links to locations of context information may be, for example, links to locations within the media context source 110 and/or a local context source. A local context source is a source of context information that resides on the user client 100. For example, a local context source may be a dictionary, thesaurus, etc., stored on the user client 100. Additionally, in some embodiments, context information may be determined based on a selected portion of a media item, some other signals (e.g., user demographics, user location, user history, user preferences, etc.) or some combination thereof.

The context identification system 115 provides context information to the user client 100 based on a context request received from user client 100. In some embodiments, a context request includes a media identifier, a location identifier, or both. A media identifier uniquely identifies a media item, such that it may be retrieved from a media database 105, or in some embodiments, context identification system 115 and/or a local memory. A location identifier is a unique data item that identifies a particular location in a media item. For example, a location identifier identifies a particular location in an e-book being read by the user, e.g., a particular word number, page number, paragraph, etc. The context identification system 115 can retrieve the requested context information from the context database using the media identifier and the location identifier. The context identification system 115 then provides the retrieved context information to the requesting user client 100. Additionally, in some embodiments, the context identification system 115 may receive feedback data from the user client 100. The context identification system 115 may update the context database using the feedback data.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The user client 100 is a computing device that executes computer program modules which allow a user to consume media from the media database 105 or from other sources. A user client 100 might be, for example, a personal computer, a tablet computer, a smart phone, a laptop computer, a dedicated e-reader, or other type of network-capable device such as a networked television or set-top box. A user client 100 comprises a server-interaction module 125 and a media player 130 that includes an information presentation module 135 in one embodiment. The functions can be distributed among the modules in a different manner than is described here.

The server interaction module 125 communicates data between the user client 100, the media database 105, the media context source 110, and the context identification system 115, via the network 120. The server-interaction module 125 sends context requests, via the network 120, to the context identification system 115. Additionally, the server-interaction module 125 may receive media items from the media database 105 or the context identification system 115, and context information from the context identification system 115, the media context source 110, or both.

The media player 130 presents media items to a user of the user client 100. The media player 130 may be configured to present media items of different media formats. Media formats may include, for example, e-books, videos, images, audio files, etc. The media player 130 retrieves a media item over the network 120 from the media database 105. Additionally, in some embodiments, the media player 130 may retrieve the requested media item from the context identification system 115.

The media player 130 includes an information presentation module 135 in one embodiment. The information presentation module 135 receives a selection of a portion of a media item presented on the user client 100. The information presentation module 135 generates and sends a context request to the context identification system 115 for context information associated with the selected portion of the media item.

The information presentation module 135 receives context information from the context identification system 115. In some embodiments, the information presentation module 135 may retrieve context information from the media context source 110 and/or the local context source using the one or more links provided by the context identification system 115.

In another embodiment, the information presentation module 135 requests context information from the context identification system 115 for a portion of the media item such that it is retrieved prior to presenting that portion of the media item. The retrieved context information may be stored in a local memory (e.g., non-volatile and/or volatile) of the user client 100. The information presentation module 135, in turn, is configured to indicate (e.g., via a graphical or audible cue) to the user that context information is available for the displayed portion of the media item.

The information presentation module 135 generates one or more context presentation cards using the received context information. A context presentation card presents context information for a portion of a media item and responds to commands from a user of the user client 100. In one embodiment, the information presentation module 135 initially presents only a portion of the context presentation card and the context information contained therein. This initial presentation is unobtrusive to the user. The user may then interact with the context presentation card to perform actions with respect to the context information (e.g., dismiss the context presentation card, maximize the context presentation card to display additional context information, display additional context presentation cards, etc.) via one or more commands. Thus, the context presentation card allows the user to selectively view the context information, and interact with the context information, in a way that does not replace the page displaying the media content or otherwise overtly interrupt the user's media consumption experience.

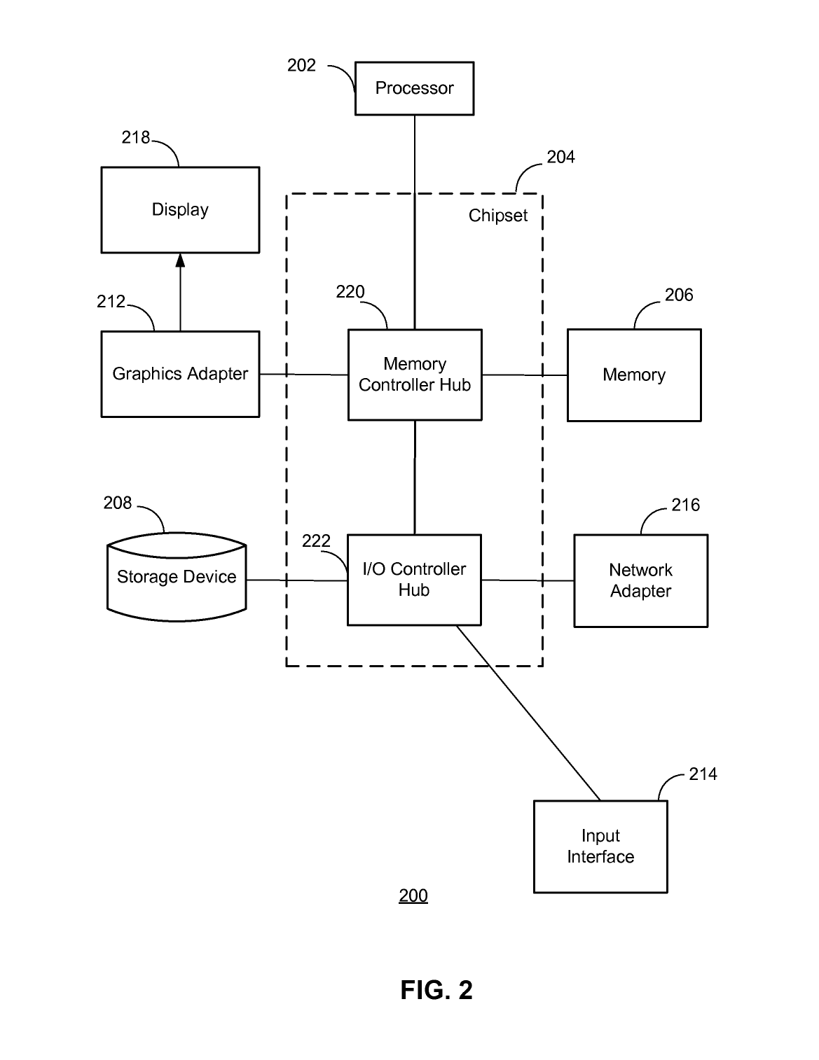

FIG. 2 is a high-level block diagram illustrating an example computer 200 for implementing one or more of the entities shown in FIG. 1. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, an input device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The input interface 214 is a touch-screen interface, a mouse, track ball, or other type of pointing device, a keyboard, or some combination thereof, and is used to input data into the computer 200. In some embodiments, the computer 200 may be configured to receive input (e.g., commands) from the input interface 214 via gestures from the user. Gestures are movements made by the user while contacting a touch-screen interface. For example, tapping a portion of the screen, touching a portion of the screen and then dragging the touched portion in a particular direction, etc. The computers 200 monitors gestures made by the user and converts them into commands (e.g., dismiss, maximize, etc.) The graphics adapter 212 displays images and other information on the display 218. The network adapter 216 couples the computer 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computer 200 used by the entities of FIG. 1 can vary depending upon the embodiment and the processing power required by the entity. For example, the context identification system 115 may include multiple computers 200 communicating with each other through a network such as in a server farm to provide the functionality described herein. Such computers 200 may lack some of the components described above, such as graphics adapters 212 and displays 218.

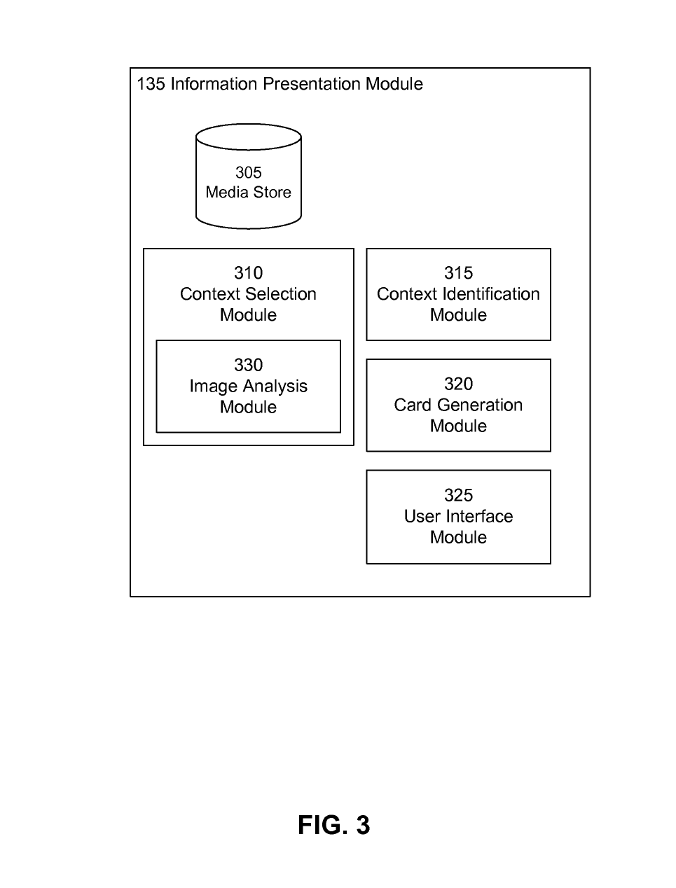

FIG. 3 is a high-level block diagram illustrating a detailed view of the information presentation module 135 within the user client 100 according to one embodiment. The information presentation module 135 is comprised of modules including a media store 305, a context selection module 310, a context identification module 315, a card generation module 320, a user interface module 325, and an image analysis module 330. Some embodiments of the information presentation module 135 have different modules than those described here. Similarly, the functions can be distributed among the modules in a different manner than is described here.

The media store 305 stores media items. The media store 305 may also store, for each media item, a profile holding metadata describing the media item, such as a media identifier, context information, or some combination thereof.

The context selection module 310 receives a selection of a portion of a media item being presented to a user by the user client 100. The context selection module 310 may receive selections from the user via the input interface 214. The context selection module 310 may receive selected portions of video, images, text, or some combination thereof.

The context selection module 310 generates and displays indicators to assist the user in selecting portions of media items. The context selection module 310 generates and displays indicators responsive to input from the user. Indicators are adjustable markers presented to the user that operate to bound a selected portion of a media item. The context selection module 310 may generate and display the indicators when instructed by the user. For example, in some embodiments, the context selection module 310 may generate and display the indicators when a user touches a location on the screen to select a portion of s displayed media item. Additionally, the context selection module 310 may adjust the location of the indicators based on input from the user. For example, the locations of the indicators may be adjusted via user gestures (e.g., touching locations on the screen).

The context selection module 310 includes an image analysis module 330 in one embodiment. The image analysis module 330 analyzes images to identify context information. In some embodiments, where the media item is a video or an image, the image analysis module 330 analyses a selected portion of the media item to identify context information. The image analysis module 330 may analyze images via, for example, optical character recognition, facial recognition, location recognition, or some other process. Based on the analysis results, the image analysis module 330 determines context information. For example, a user may select a portion of the media item displaying a road sign. The context selection module 310 then performs optical character recognition on the selected portion to identify the text of the sign. The image analysis module 317 then passes the results of the analysis to the context identification module 315 for context information identification.

The context identification module 315 determines context information based on the selected portion of the media item. The context identification module 315 generates and sends a context request to the context identification system 115, based on the selected portion of the media item. For example, the context identification module 315 may send a context request to the context identification system 115 for context information associated with the selected portion of an e-book, image, and/or video. The context identification module 315 also receives context information from the context identification system 115. In embodiments, where the received context information includes one or more links to one or more media context sources 110 and/or a local context source, the context identification module 315 may retrieve context information from the sources using the received one or more links.

In some embodiments, the context identification module 315 determines context information for a portion of the media item such that it is retrieved prior to presenting that portion of the media item. For example, the context identification module 315 may send a context request to the context identification system 115 for a portion of the media item such that it is retrieved prior to displaying that portion of the media item. The retrieved context information may be stored in a local memory (e.g., memory 206 and/or storage device 208). Additionally, in some embodiments, the context identification module 315 indicates to the user which parts of a displayed portion of a media item are associated with context information. For example, the context identification module 315 may visually or audibly indicate to the user that content has associated context information.

The card generation module 320 generates one or more context presentation cards using the context information. In one embodiment, the context presentation card is a rectangular (i.e., card-shaped) object displayed in a user interface. The context presentation card displays context information, such as textual or graphical information within its borders, as if the information were written on the card.

In some embodiments, the context presentation cards are generated based on the type of information included within the context information. Thus, different context presentation cards may be generated for different types of context information. Additionally, in some embodiments, the card generation module 320 may generate context presentation cards that combine different types of information included within the context information. For example, the card generation module 320 may create a context presentation card using definition information, geographic information, image information, some other type of information, or some combination thereof. For example, a context presentation card may include textual information defining “Freeport” as a city in Maine, and include a graphical map of Freeport, Me. Additionally, in some embodiments, the card generation module 320 may include one or more links to additional context information. The context presentation card may include, for example, a link to one or more media context sources 110 and/or a local context source. The card generation module 320 provides the generated one or more context presentation cards to the user-interface module 325.

The user interface module 325 presents context presentation cards to the user. The user interface module 325 presents media items and/or context presentation cards (or portions thereof) via a content viewing area. In one embodiment, the user interface module 325 presents a partial portion of the context presentation card containing a subset of the context information. In some embodiments, the presented context presentation card overlays some (e.g., 20% of the content viewing area), but not all of, the media item being presented to the user. For example, the user interface module 325 may show a portion of the context presentation card extending from an edge of a user interface toward an opposing edge of the user interface. In some embodiments, only a subset of the context information within the context presentation card is presented, in others all of the context information included in the context presentation card is presented. Additionally, in some embodiments, the user interface module 325 may present multiple information cards (or portions thereof) to the user. Additionally, in some embodiments, the user interface module 325 presents one or more context presentation cards in a focus position. A context presentation card in the focus position occupies a central position of the content viewing area. In alternate embodiments, the focus position may be located in the top half of the content viewing area.

The user interface module 325 may present context presentation cards in different states, for example, a peeking state, a minimized state, and a maximized state. Additionally, in other embodiments, the user interface module 325 may present context presentation cards in other states.

A context presentation card in the peeking state is meant to alert the user there is context information available for the selected portion of the media item, while minimizing any disruption of the user's consumption of the media item. In one embodiment, a context presentation card in a peeking state extends from an edge of the content viewing area towards the opposing edge, and only displays a preview portion of the context presentation card. The preview portion indicates to the user some minimal context information associated with the selected portion is available for consumption. The preview portion may present, for example, the selected portion of a media item, provide pronunciation information for the selected portion, provide some other limited display of the context information (e.g., one or two lines of information, 20% of content display area, etc.), or some combination thereof.

A context presentation card in the minimized state displays all of the context information contained in the context presentation card, but is positioned along an edge of the content viewing area. A minimized context presentation card is positioned along an edge of the content viewing area and extends towards an opposing edge of the content viewing area. The side of the context presentation card closest to the edge, may actually share the edge, or be close to the edge. For example, the side of a card may be displayed extending from an edge of the content viewing area such that it overlaps a portion (e.g., 20%) of the content viewing area and shows the context information contained on the context presentation card. Thus, the context information in the context presentation card may be presented to the user in an unobtrusive manner (versus, e.g., displaying the context presentation card in the middle of the displayed area, or only displaying the context information card and not the media item.

A context presentation card in a maximized state is located in a focus position of the content viewing area. In some embodiments, the displayed content not overlaid with a context presentation card is obscured via for example, a semi-transparent or a solid color layer. Additionally, in embodiments where a plurality of context presentation cards are associated with the selected portion of the media item, a plurality of context presentation cards may be presented in the maximized state. For example, the user interface module 325 may present multiple context presentation cards as separate cards or a context presentation card stack to the user. A context presentation card stack is a group of context presentation cards where the top most context presentation card is displayed on top of any additional context presentation cards. A user is able to select other context presentation cards in the context presentation card stack for display, by for example, selecting a displayed side of the desired card using an input interface.

The user interface module 325 recognizes a plurality of card commands from the user that allow the user to interact with a card. The user interface module 325 may receive a card command acting on a context presentation card from the user. A card command causes a context presentation card to move from one state to another (e.g., maximize to minimize). Card commands include, for example, minimize, maximize, dismiss, preview, and select. In some embodiments, the commands are received by the user interface module 325 via gestures made by the user using an input interface. Additionally, in some embodiments, as a result of one or more of the above commands, one or more context presentation cards may traverse the display area, grow in size, shrink in size, be removed from display, display additional context presentation cards, or some combination thereof, as part of an animated sequence of images. Alternatively, as a result of one or more of the above commands, the user interface module 325 may cause one or more context presentation cards to jump directly between states without the animated sequence of images.

A minimize command causes a context presentation card to occupy a minimized state. In some embodiments, a user may minimize a context presentation card by selecting a context presentation card in the peeking state and dragging the context presentation card toward an opposing edge. An opposing edge is the edge opposite the edge of the content viewing area which the context presentation card is positioned along. As the display area of the context presentation card increases additional context information included in the context presentation card is incrementally presented to the user. The user is thus able to control the amount of context information displayed by the context presentation card. In alternate embodiments, if a user selects a context presentation card in the peeking state, the user interface module 325 automatically minimizes the context presentation card such that all of its context information is being displayed. Additionally, in some embodiments, where multiple cards are being minimized (e.g., context presentation card stack), only one of the context presentation cards is minimized (e.g., top most card) and the remaining context presentation cards are dismissed. In alternate embodiments, the entire context presentation card stack may be minimized such that the user is able to cycle through other context presentation cards in the minimized context presentation card stack.

A maximize command causes the user interface module 325 to move one or more context presentation cards towards to a focus position. In some embodiments, a user may maximize context presentation cards by selecting a minimized context presentation card, and dragging the minimized context presentation card towards the opposing edge. The user interface module 325 recognizes this gesture as a maximize command. In alternate embodiments, if a user selects a minimized card, the user interface module 325 automatically executes a maximize command. Additionally, in some embodiments, if multiple context presentation cards are available for a selected portion of the media item, a maximize command may cause the user interface module 325 to present multiple context presentation cards to the user.

A dismiss command causes the user interface module 325 to remove the context presentation card from display. In one embodiment, if a context presentation card along an edge of the displayed media item is in a peeking state, or minimized state, and a dismiss command is received, the edge of the context presentation card furthest from the edge (i.e. the opposing edge) moves toward the edge until no part of the context presentation card is displayed. In one embodiment, if a context presentation card is in a maximized state and a dismiss command is received, the context presentation card being dismissed moves toward an edge until it is no longer displayed. Additionally, in embodiments, where multiple context presentation cards are displayed, a single dismiss command may be applied to one or more of the multiple context presentation cards. A user may provide a dismiss command for one or more context presentation cards, to the user interface module 325 by swiping in a direction on the touch-screen interface. The direction may be, for example, towards an edge of the display area, across the context presentation card, or some other direction. Additionally, in some embodiments a user may dismiss the minimized context presentation card through a button on the user client 100 (e.g., a back button).

A preview command causes a context presentation card to occupy a peeking state. The user interface module 325 may receive a preview command for one or more context presentation cards, from a user (e.g., detecting a user swiping in a direction on the input interface). The direction may be, for example, towards an edge of the displayed content area. When a preview command is received, the user interface module 325 moves the context presentation card toward the edge of the displayed content item, until only the preview portion of the context presentation card is presented to the user. Additionally, in some embodiments, where multiple cards are being transitioned to a peeking state (e.g., from a context presentation card stack), only one of the context presentation cards is transitioned to the peeking state (e.g., top most card) and the remaining context presentation cards are dismissed. In alternate embodiments, the entire context presentation card stack may be transitioned to the peeking state such that a preview portion of the top most card is presented to the user, and the user is able to cycle through preview portions of other context presentation cards in the peeking state of the context presentation card stack.

A select command causes the user interface module 325 to select a particular context presentation card for display or allow a user to interact with a portion of a displayed card. A select command may be executed via an input device (e.g., double tapping, selecting a button, etc.). In embodiments, where multiple context presentation cards are being displayed (e.g., via a context presentation card stack) a select command allows a user to select a context presentation card for presentation to the user. Additionally, the select command allows a user to interact with context information presented in a card. For example, a user may select a link being presented in the context presentation card, select a map being presented in the context presentation card, etc.

In some embodiments the user interface module 325 may present to a user multiple cards associated with differing context for the same selected portion of the media item. This may occur, for example, when a selected portion of a media item has different meanings depending on how it is used. The user may then review the displayed cards of differing context, and dismiss the card displaying the wrong context. Alternatively, a user may select the card of correct context, and the user interface module 325 automatically dismisses the non-selected card. Additionally, in some embodiments, after the user has identified the correct card, the user interface module automatically presents any additional cards of similar context (e.g., via a context presentation card stack).

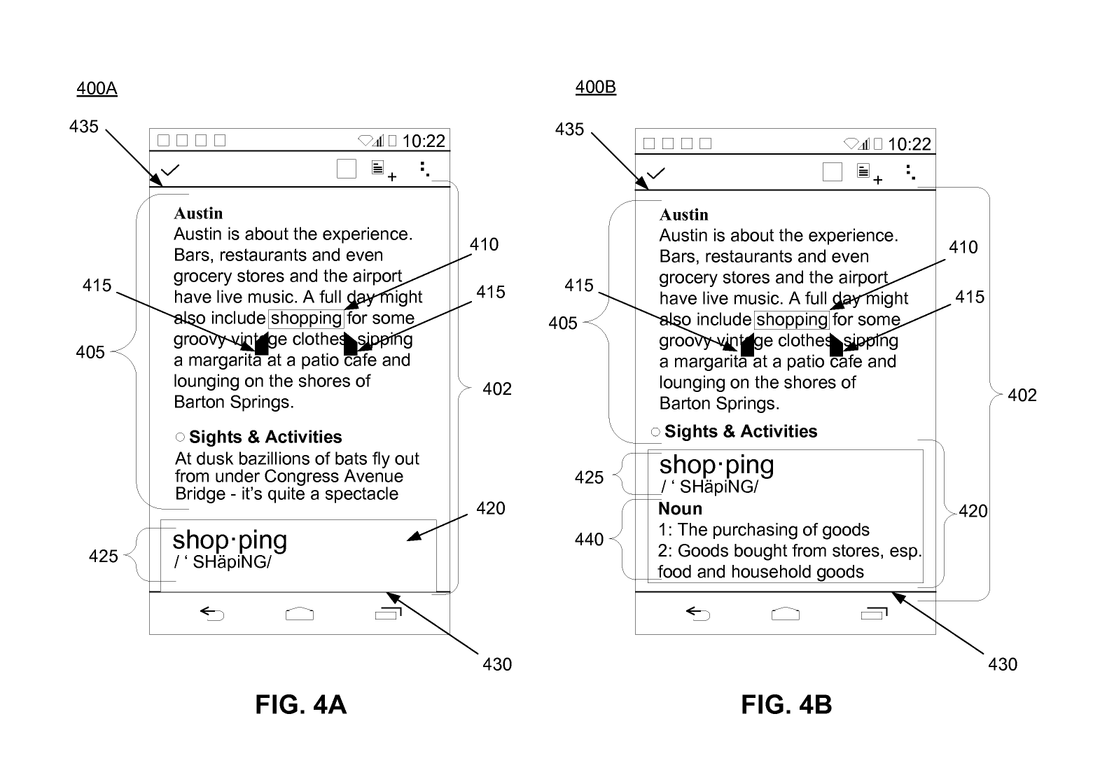

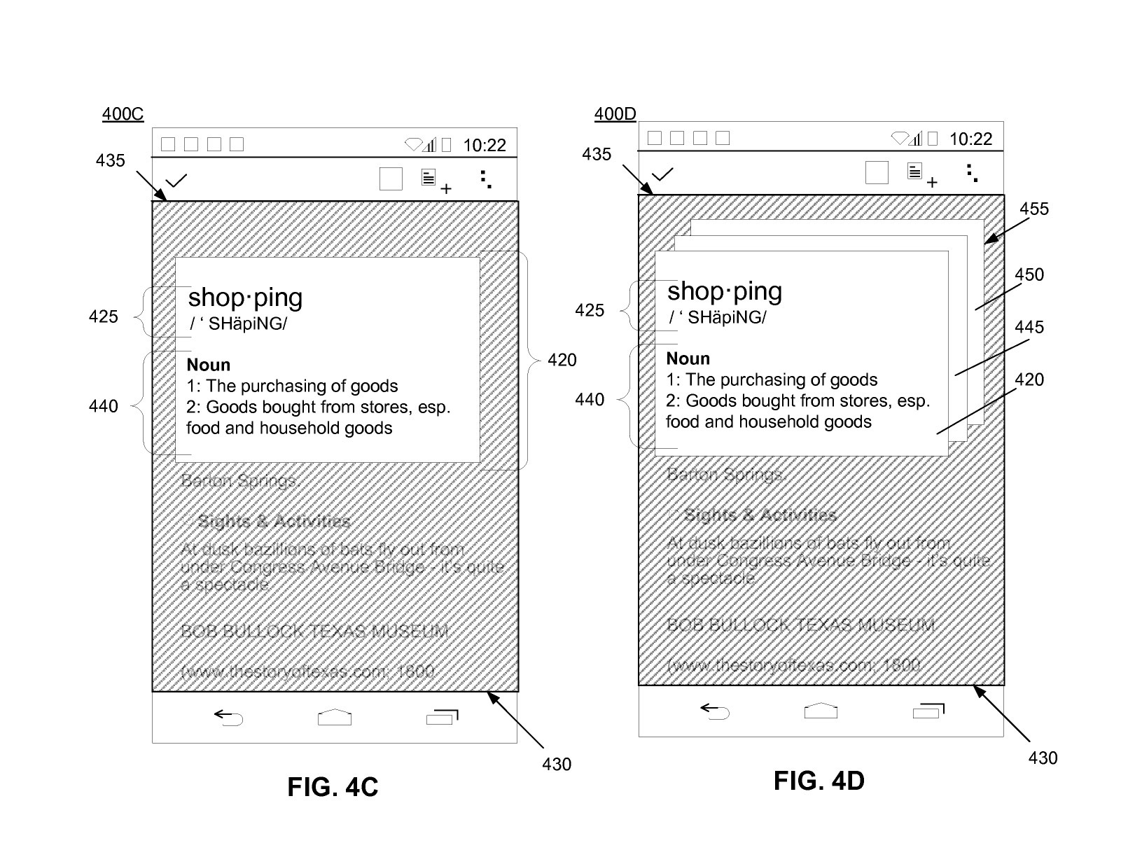

Once the user interface module 325 receives a selection from the user indicating which context presentation card is correct, the user interface module may send feedback data to the context identification system 115. Feedback data may include, for example, a media identifier for the media item, the selected portion of the media item, and the context information and/or context identifier associated with the context presentation card selected by the user. The context identification system 115 updates the context database using the feedback information, accordingly, the context identification system 115 is able to provide the correct context information for the selected portion of the media item in response to subsequent context requests. FIG. 4A illustrates an example of a user interface 400A displayed by the user client 100 showing a context presentation card in a peeking state according to an embodiment. In one embodiment, the user interface module 325 generates the user interface 400A, and similarly, user interfaces 400B-400D, and 500 described below. The user interface 400A includes a content viewing area 402, a displayed portion 405 of a media item, a selected portion 410 of the media item, indicators 415 that indicate the selected portion 410, and a portion of a context presentation card 420. In FIG. 4A a user has selected the word “shopping” with indicators 415. The user interface 400 presents a portion of a context presentation card 420 in a peeking state, such that only a portion of the context information is presented to the user. A context presentation card 420 in a peeking state extends from an edge 430 of the content viewing area 400 towards an opposing edge 435 of the content viewing area 400, and only displays a preview portion 425 of the context presentation card 420.

FIG. 4B illustrates an example of the user interface 400B displayed by the user client 100 showing a context presentation card in a minimized state according to an embodiment. The context presentation card 420 is minimized, and presents the preview portion 425 in addition to remaining context information 440. In this example, the remaining context information 440 includes definition information for the selected portion 410 of the media item.

FIG. 4C illustrates an example of the user interface 400C displayed by the user client 100 showing a context presentation card in a maximized state according to an embodiment. The maximized context presentation card occupies the focus position and overlays the displayed portion of the media item. Additionally, the displayed portion of the media item not overlaid with a context presentation card is obscured by a translucent layer.

FIG. 4D illustrates an example of the user interface 400D displayed by the user client 100 showing multiple context presentation cards in a maximized state according to an embodiment. In this embodiment, the user interface 400 shows multiple context presentation cards in a context presentation card stack including context presentation cards 420, 445, and 450. A user is able to select other context presentation cards in the stack for display by, for example, selecting a displayed side of the desired card. For example, a user desiring to select context presentation card 450 may select a side 455 of the card.

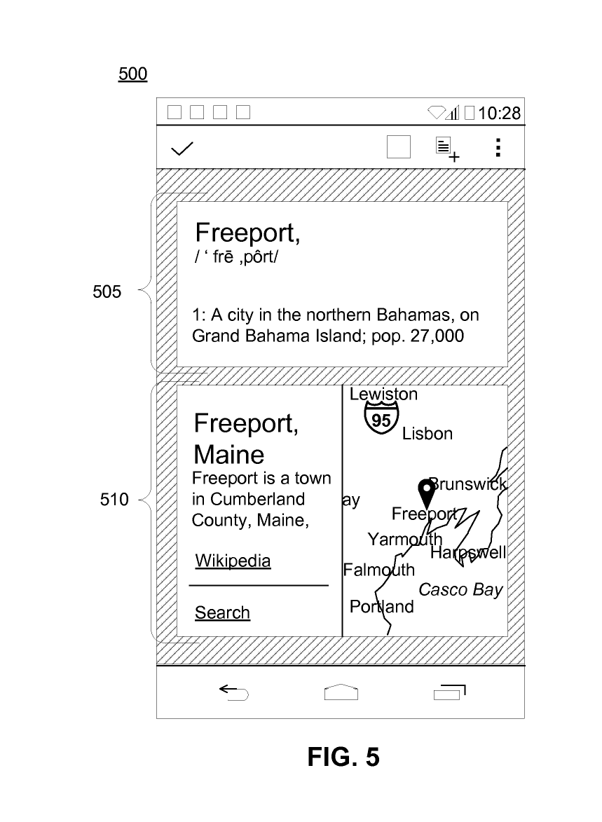

FIG. 5 illustrates an example of a user interface 500 displayed by the user client 100 showing multiple context presentation cards of differing context according to an embodiment. The selected portion of the media item in FIG. 5 is the word “Freeport.” A context presentation card 505 presents context information associated with “Freeport” a town in the northern Bahamas. In contrast, the context presentation card 510 presents context information associated with “Freeport” a town in Maine.

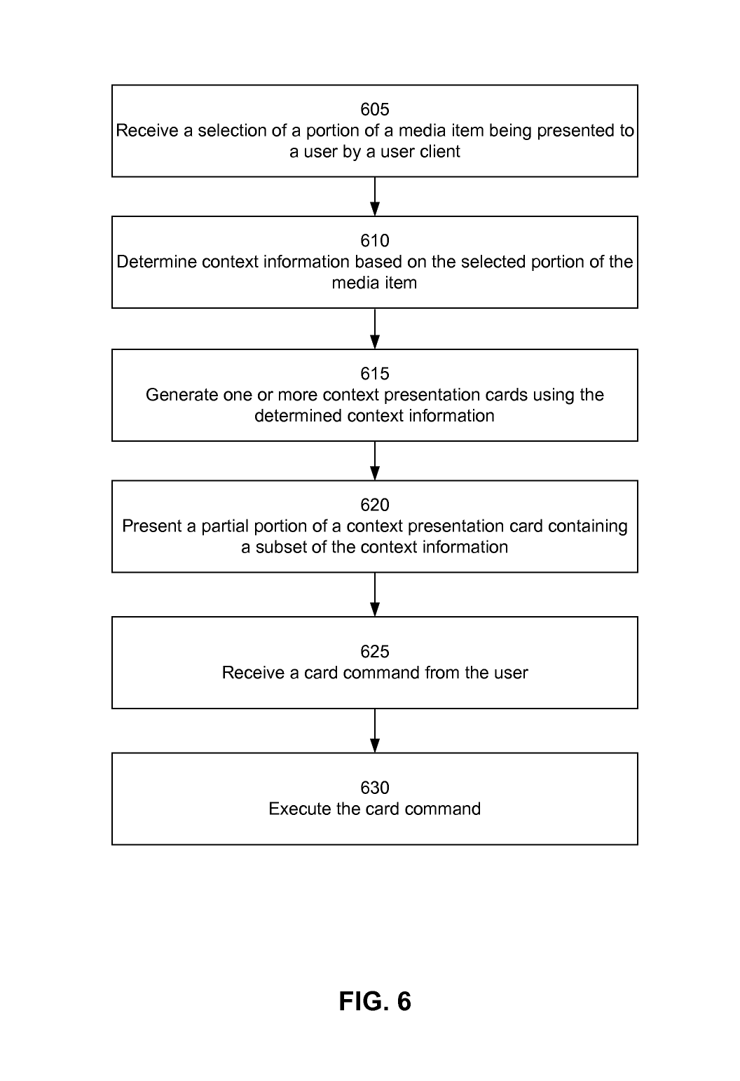

FIG. 6 is a flowchart illustrating the process of presenting context information to a user according to one embodiment. In one embodiment, the process of FIG. 6 is performed by the user client 100. Other entities may perform some or all of the steps of the process in other embodiments. Likewise, embodiments may include different and/or additional steps, or perform the steps in different orders.

In this embodiment the user client 100 receives 605 a selection of a portion of a media item being presented to a user by the user client 100. The user client 100 determines 610 context information based on the selected portion of the media item. The user client 100 sends a context request to the context identification system 115, based on the selected portion of the media item. The user client 100 then receives context information from the context identification system 115. In some embodiments, the user client 100 may receive one or links from the context identification system 115. In such cases, the user client retrieves context information from the media context source 110 and/or a local context source using the one or more links. In alternate embodiments, the user client 100 may retrieve context information from the context identification system 115, the media context source 110, a local context source, or some combination thereof, for some, or all of, the media item prior to presenting a portion of the media item to the user.

The user client 100 generates 615 one or more context presentation cards using the determined context information. In some embodiments context presentation cards are generated based on the type of information included within the context information. Additionally, in some embodiments, the user client 100 may generate context presentation cards that combine different types of information included within the context information. Additionally, in some embodiments, the user client 100 may include one or more links to context information.

The user client 100 presents 620 a partial portion of a context presentation card containing a subset of the context information. For example, the user client 100 may present a preview portion of a card (i.e. context presentation card is in a peeking state).

The user client 100 receives 625 a card command from the user. The user client 100 then executes 630 the card command. For example, a user may maximize the context presentation card using gestures.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for automated dictionary generation. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

1. A computer-implemented method of presenting context information to a user of a user client, comprising:
receiving a selection of a portion of a media item being presented to the user by the user client;
determining context information based on the selected portion of the media item;
generating a context presentation card using the determined context information; and
presenting a partial portion of the context presentation card containing a subset of the context information to the user.

2. The computer-implemented method of claim 1, wherein presenting a partial portion of the context presentation card containing a subset of the context information to the user comprises:
providing a graphical user interface (GUI) illustrating the context presentation card positioned along an edge of a content viewing area, and the portion of the context presentation card presented to the user extends from the edge towards an opposing edge of the content viewing area, and the portion comprises a preview portion of the card.

3. The computer-implemented method of claim 1, further comprising:
providing a graphical user interface (GUI) illustrating the context presentation card positioned along an edge of a content viewing area, and the portion of the context presentation card presented to the user extends from the edge towards an opposing edge of the content viewing area, and the portion comprises a preview portion of the card;
receiving a command to minimize the context presentation card from the user; and
responsive to receiving the command to minimize, moving a side of the context presentation card furthest from the edge toward the opposing edge until the entire context information associated with the context presentation card is presented to the user.

4. The computer-implemented method of claim 1, further comprising:
providing a graphical user interface (GUI) illustrating the context presentation card positioned along an edge of a content viewing area, the portion of the context presentation card presented to the user extends from the edge towards an opposing edge of the content viewing area, and the portion presents the entire context information associated with the context presentation card to the user;
receiving a command to maximize the context presentation card from the user; and
responsive to receiving the command to maximize, moving context presentation card to a focus position centrally located in the content viewing area.

5. The computer-implemented method of claim 4, further comprising:
generating a second context presentation card using the retrieved context information, and
presenting a context presentation card stack comprising the context presentation card stacked on top off the second context presentation card, where a side of the second context presentation card is visible to the user such that when selected the second context presentation card moves to the top of the context presentation card stack.

6. The computer-implemented method of claim 1, wherein the media item is a video or image and determining context information based on the selected portion of the media item further comprises:
analyzing the media item using optical character recognition to determine text information;
requesting context information from a server based on the determined text information; and
receiving the requested context information.

7. The computer-implemented method of claim 1, wherein the context information includes definition information, geographic information, and image information, each associated with the selected portion of the media item.

8. A non-transitory computer-readable storage medium storing executable computer program instructions for presenting context information to a user of a user client, the instructions executable to perform steps comprising:
receiving a selection of a portion of a media item being presented to the user by the user client;
determining context information based on the selected portion of the media item;
generating a context presentation card using the determined context information; and
presenting a partial portion of the context presentation card containing a subset of the context information to the user.

9. The computer-readable medium of claim 8, wherein presenting a partial portion of the context presentation card containing a subset of the context information to the user comprises:
providing a graphical user interface (GUI) illustrating the context presentation card positioned along an edge of a content viewing area, and the portion of the context presentation card presented to the user extends from the edge towards an opposing edge of the content viewing area, and the portion comprises a preview portion of the card.

10. The computer-readable medium of claim 8, further comprising:
providing a graphical user interface (GUI) illustrating the context presentation card positioned along an edge of a content viewing area, and the portion of the context presentation card presented to the user extends from the edge towards an opposing edge of the content viewing area, and the portion comprises a preview portion of the card;
receiving a command to minimize the context presentation card from the user; and
responsive to receiving the command to minimize, moving a side of the context presentation card furthest from the edge toward the opposing edge until the entire context information associated with the context presentation card is presented to the user.

11. The computer-readable medium of claim 8, further comprising:
providing a graphical user interface (GUI) illustrating the context presentation card positioned along an edge of a content viewing area, the portion of the context presentation card presented to the user extends from the edge towards an opposing edge of the content viewing area, and the portion presents the entire context information associated with the context presentation card to the user;
receiving a command to maximize the context presentation card from the user; and
responsive to receiving the command to maximize, moving context presentation card to a focus position centrally located in the content viewing area.

12. The computer-readable medium of claim 11, further comprising:
generating a second context presentation card using the retrieved context information, and
presenting a context presentation card stack comprising the context presentation card stacked on top off the second context presentation card, where a side of the second context presentation card is visible to the user such that when selected the second context presentation card moves to the top of the context presentation card stack.

13. The computer-readable medium of claim 8, wherein the media item is a video or image and determining context information based on the selected portion of the media item further comprises:
analyzing the media item using optical character recognition to determine text information;
requesting context information from a server based on the determined text information; and
receiving the requested context information.

14. The computer-readable medium of claim 8, wherein the context information includes definition information, geographic information, and image information, each associated with the selected portion of the media item.

15. A system for presenting context information to a user of a user client, comprising:
a processor configured to execute modules; and
a memory storing the modules, the modules comprising:
a context selection module configured to receive a selection of a portion of a media item being presented to the user by the user client,
a context identification module configured to determine context information based on the selected portion of the media item,
a card generation module configured to generate a context presentation card using the determined context information, and
a user interface module configured to present a partial portion of the context presentation card containing a subset of the context information to the user.

16. The system of claim 15, wherein the user interface module is further configured to:
provide a graphical user interface (GUI) illustrating the context presentation card positioned along an edge of a content viewing area, and the portion of the context presentation card presented to the user extends from the edge towards an opposing edge of the content viewing area, and the portion comprises a preview portion of the card.

17. The system of claim 15, wherein the user interface module is further configured to:
provide a graphical user interface (GUI) illustrating the context presentation card positioned along an edge of a content viewing area, and the portion of the context presentation card presented to the user extends from the edge towards an opposing edge of the content viewing area, and the portion comprises a preview portion of the card;
receive a command to minimize the context presentation card from the user; and
responsive to receiving the command to minimize, move a side of the context presentation card furthest from the edge toward the opposing edge until the entire context information associated with the context presentation card is presented to the user.

18. The system of claim 15, wherein the user interface module is further configured to:
provide a graphical user interface (GUI) illustrating the context presentation card positioned along an edge of a content viewing area, the portion of the context presentation card presented to the user extends from the edge towards an opposing edge of the content viewing area, and the portion presents the entire context information associated with the context presentation card to the user;
receive a command to maximize the context presentation card from the user; and
responsive to receiving the command to maximize, move context presentation card to a focus position centrally located in the content viewing area.

19. The system of claim 18, wherein the user interface module is further configured to:
generate a second context presentation card using the retrieved context information, and
present a context presentation card stack comprising the context presentation card stacked on top off the second context presentation card, where a side of the second context presentation card is visible to the user such that when selected the second context presentation card moves to the top of the context presentation card stack.

20. The system of claim 15, wherein the context information includes definition information, geographic information, and image information, each associated with the selected portion of the media item.
